(19) United States
(12) Patent Application Publication
(10) Pub. No.: US 2004/0080404 A1
(43) Pub. Date: Apr. 29, 2004

(54) Distance detection and display system for use in a vehicle

(76) Inventor: Tommy E. White, Rochester Hills, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/281,913

(22) Filed: Oct. 28, 2002

(51) Int. Cl. B60Q 1/00

(52) U.S. Cl. 340/435

(57) ABSTRACT

A distance measuring and display system displays, on the rear windshield of a vehicle, a representation of the distance between the rear end of the vehicle and an obstacle behind the vehicle. Distance measuring equipment, including at least one sensor on the rear of the vehicle, measures the distance which is then displayed.

### TECHNICAL FIELD

The present invention generally relates to vehicular collision avoidance systems, and more particularly to an apparatus for determining the distance between a vehicle and an obstacle to the rear of the vehicle and for displaying that distance on the rear windshield of the vehicle.

### BACKGROUND OF THE INVENTION

In most circumstances, the operator of a vehicle such as an automobile, truck, and the like has adequate visibility for the safe operation of the vehicle. Furthermore, the operator's visibility is enhanced through the well known use of rearview and sideview mirrors. Despite this, however, there are situations when a driver's visibility is limited or eliminated entirely. For example, when a driver is maneuvering a vehicle into a parking space on the side of the road between two other vehicles, the driver is often required to perform one or more iterations of backing up and pulling forward between the two vehicles without contacting either vehicle. The driver, however, generally cannot see the rear portion of the driver's vehicle that might make such contact. This is especially true when, for example, a vehicle is backing up to a loading dock for the purpose of loading and unloading.

In an attempt to solve problems of this nature, vehicular collision avoidance systems have been developed and are now relatively common. Such systems may include an apparatus for determining the distance between a vehicle and an obstacle in the vehicle's path and apparatus for displaying that distance or at least alerting the operator of an impending collision. For example, U.S. Pat. No. 4,903,004 issued Feb. 20, 1990, and entitled “All-Weather Digital Distance Measuring and Signaling System” describes a distance measuring and signaling system for a vehicle specifically intended for accurately measuring distances from obstructions, such as those behind a truck as it is being backed up. An array of transducer devices having independent sending and receiving capabilities are mounted on a support frame, such as a rear bumper. A pulsed signal emanating from a transistor amplifier circuit is timed as it is converted to an ultrasonic wave signal by each transducer device, is simultaneously emitted and received by the transducer devices, and is returned as a pulsed signal. This signal is returned after bouncing back from an obstruction, and the time of the return is converted into a distance value by digital converter circuitry. The digital converter circuitry in turn sends the signal to a digital display device. U.S. Pat. No. 4,674,073 issued Jun. 16, 1987, and entitled “Reflective Object Detecting Apparatus” describes an apparatus wherein a plurality of ultrasonic transmitting elements and ultrasonic receiving elements are provided and are electrically switched in a sequential manner to allow the existence of an obstacle to be detected. The distance to the object and a particular region at which it is detected is displayed. The ultrasonic transmitting elements and the ultrasonic receiving elements are alternately disposed in a linear array.

Unfortunately, known systems of the type described above generally require the operator to divert his attention from performing functions critical to the safe operation of the vehicle in order to look at the display.

In view of the above, it would be desirable to provide a distance detection and display system which avoids the above described disadvantage by providing a distance display that is easily viewed by an operator of a vehicle as the vehicle is being maneuvered in a rearward direction.

### SUMMARY OF THE INVENTION

According to an aspect of the invention there is provided a distance measuring and display system for use on a vehicle having a rear windshield. The system comprises at least one distance measuring sensor for measuring the distance between the rear of the vehicle and an obstacle at the rear of the vehicle. A display system coupled to the sensor displays the distance on the rear windshield.

According to a further aspect of the invention there is provided an apparatus for projecting an image on a rear windshield of a vehicle. The apparatus comprises a display for generating an image, and first means coupled to the display for projecting the image onto the rear windshield.

According to a still further aspect of the invention there is provided a method for displaying on a vehicle's rear windshield a representation of a distance between the vehicle and an obstacle to the rear of the vehicle comprising measuring the distance, and displaying the representation on the rear windshield.

### BRIEF DESCRIPTION OF THE DRAWINGS

The following drawings are illustrative of particular embodiments of the invention and therefore do not limit the scope of the invention, but are presented to assist in providing a proper understanding of the invention. The drawings are not to scale (unless so stated) and are intended for use in conjunction with the explanations in the following detailed description. The present invention will hereinafter be described in conjunction with the appended drawing figures, wherein like numerals and like elements, and:

FIG. 1 illustrates a vehicle attempting to park between two other vehicles at the side of a roadway;

FIG. 2 illustrates a driver looking through the rear windshield of a vehicle as the vehicle is being driven backwards;

FIG. 3 illustrates the inventive rear windshield display apparatus; and

FIG. 4 is a block diagram of the inventive distance detection and rear windshield display system.

### DESCRIPTION OF THE PREFERRED EMBODIMENT

The following description is exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

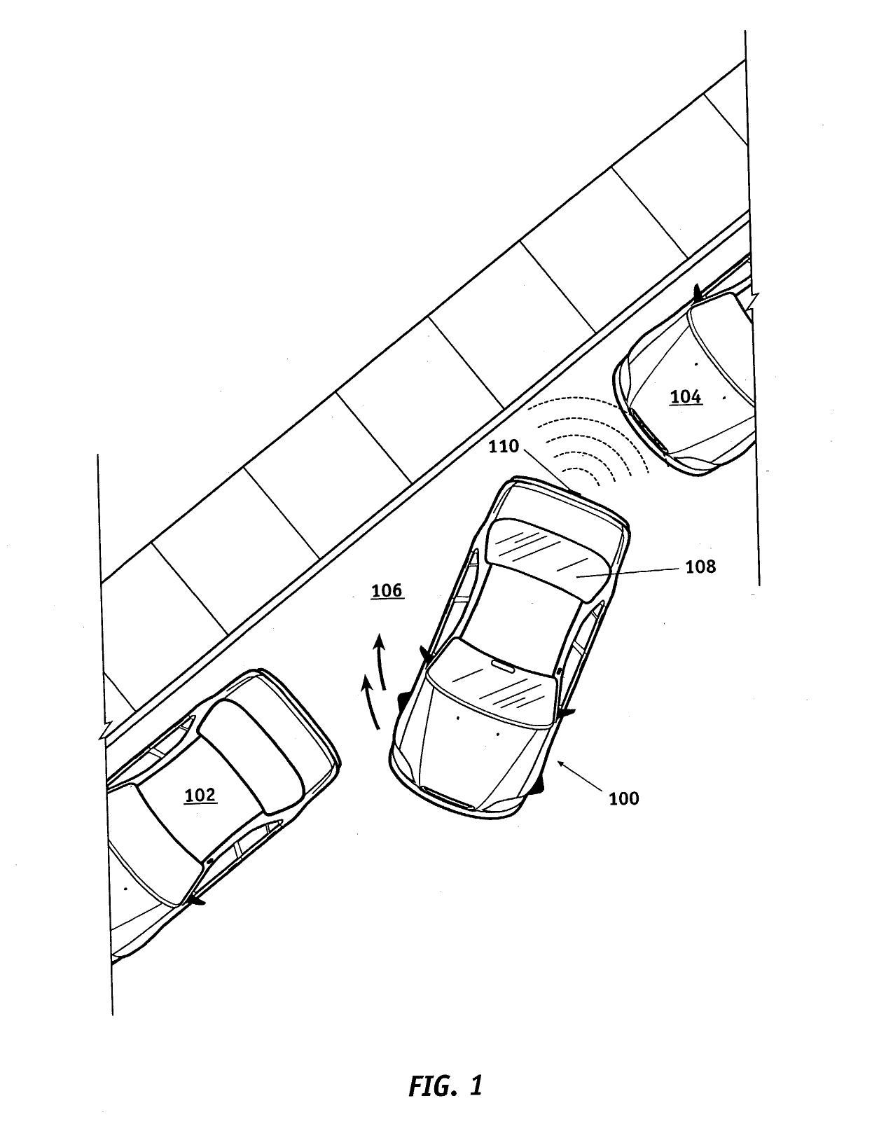

As stated previously, there are situations when a driver's visibility is limited or eliminated entirely, as for example when a driver is maneuvering a vehicle into a parking space on the side of a road between two other vehicles. This situation is illustrated in FIG. 1, which illustrates a vehicle 100 attempting to park in parking space 106 between two other vehicles 102 and 104 parked along the side of the roadway. As is well known, in such situations a driver is often required to perform one or more iterations of backing up and pulling forward, each time exercising extreme caution so as to not hit the vehicle behind when backing up or the vehicle in front when pulling forward. When backing up, a driver commonly looks out rear windshield 108 in order to estimate the distance to the vehicle parked to the rear. Notwithstanding, very often a driver will, in fact, make contact with vehicle 104 possibly creating the need for expensive repairs.

In accordance with the present invention, at least one distance measuring device 110 is provided at the rear portion of vehicle 100. This sensor may be ultrasonic, radar, or an infrared emitter and receiver which transmits energy that bounces off an obstacle; e.g., the rear vehicle 104. That energy that is bounced or reflected is received back, and the distance is determined by measuring the time required for the energy to travel to and from the obstacle. That measurement is then processed and converted into a distance measurement in the well known manner. Such systems are well known, and the interested reader is referred to the above cited patents, the teachings of which are hereby incorporated by reference.

The present invention comprises as distance measuring system wherein the distance between a vehicle and an obstacle to the rear of the vehicle is displayed in the vehicle's rear windshield. In this manner, a driver may easily determine the remaining distance to an obstacle to the rear of the operator's vehicle.

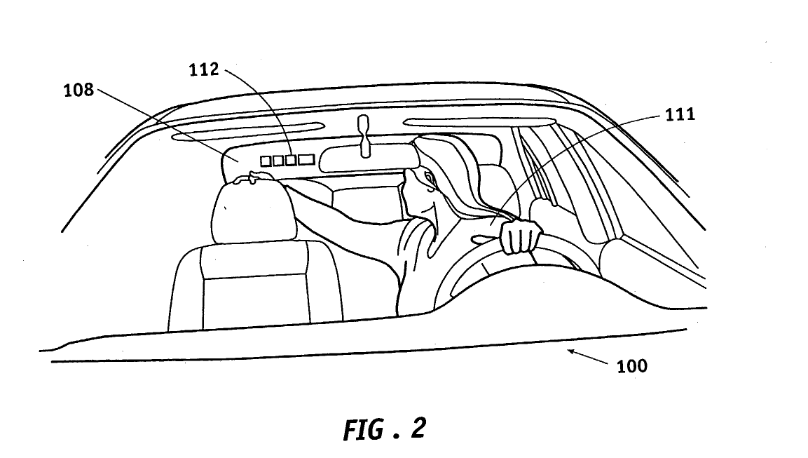

Referring to FIG. 2, vehicle 100 is equipped with a rear windshield 108. As can be seen, operator 111 of vehicle 100 is turned so as to look out rear windshield 108. This would be the typical scenario if operator 111 were driving vehicle 100 in a reverse direction. However, according to the teachings of the present invention, driver 111 is assisted by a display 112 which is projected onto the rear windshield. This display contains distance information (e.g., numerical) indicating to the driver how far the rear of the vehicle is from an obstacle. In this manner, low speed collisions such as the type which normally occur in such situations (i.e., backing into a parking space) are substantially avoided which, in turn, represents a significant safety improvement and results in reduced repair costs.

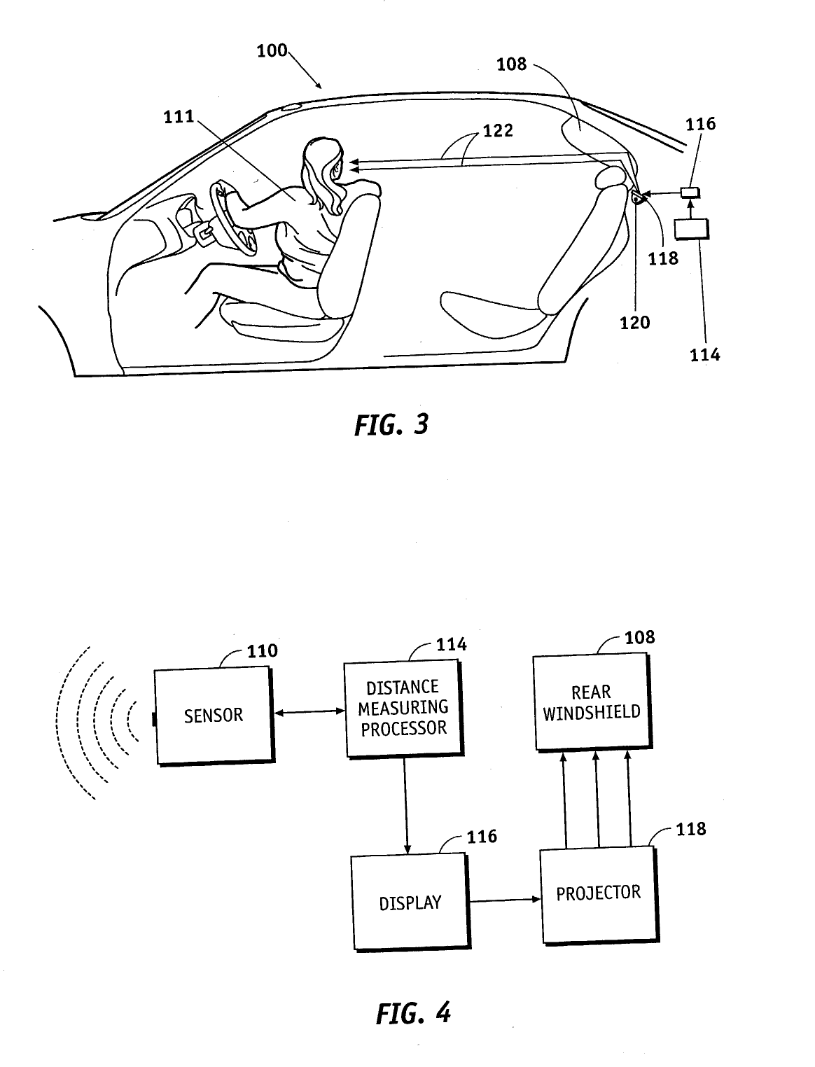

Referring to FIG. 3, driver 111 is again illustrated looking through rear windshield 108 as he is guiding vehicle 100 in a rearward direction. Distance measuring processor 114 of the type described above retrieves and processes reflected signals, and determines the distance between the vehicle mounted sensor and an obstacle to the rear of the vehicle. This distance data is then presented to a projection display at unit 116. Projection unit 116 may comprise a housing, an optical system disposed in a portion of the housing, and a display device disposed in another portion of the housing. Display device 116 may comprise, for example, a light transmissive type liquid crystal display device including a liquid crystal display cell. The liquid crystal display cell driven by a display driver (not shown) forms a display image which represents data related to the distance between the vehicle and an obstacle at the rear of the vehicle. The light which passes through the LCD cell in the form of displayed data is projected onto windshield 108 by means of a reflecting mirror 118. As can be seen, reflecting mirror 118 may be pivoted about point 120 to enable the proper positioning of the virtual image 112 (FIG. 2) to render it easily viewable by operator 111 as is indicated by arrows 122.

Projective display systems are well known. For example, U.S. Pat. No. 4,711,544 issued Dec. 8, 1987 entitled “Display System For A Vehicle”, describes a display system having a display unit for projecting a display image of a display device onto a front glass of a vehicle. This patent, the teachings of which are hereby incorporated by reference, describe a system wherein the entire surface of the front windshield can be utilized as a display image projection surface and thus the virtual image of the display can be formed at a desired position suitable for viewing by the driver. For additional information, the interested reader is directed to U.S. Pat. No. 5,519,536 issued May 21, 1996, entitled “Warning Device For Displaying Information In A Vehicle” and U.S. Pat. No. 5,805,119 issued Sep. 8, 1998 entitled, “Vehicle Projected Display Using Deformable Mirror Device”.

FIG. 4 is a block diagram representative of the inventive rear windshield display system. The reference numerals have been chosen to correspond to like elements in FIGS. 1, 2, and 3. As can be seen, sensor 110 is coupled to distance measuring processor 114. Sensor 110 transmits signals which are reflected back from an obstacle. Thus, sensor 110 may be of any suitable variety including ultrasonic, radar, or infrared. The reflected data is then processed in distance measuring processor 114 to generate signals corresponding to the distance between the rear of vehicle 100 and an obstacle to the rear thereof. This information is displayed in display unit 116 which is optically coupled to a projector 118. Projector 118 then projects the distance indicia onto rear windshield 108 for viewing by a driver.

Thus, there has been provided, in accordance with the invention, an improved vehicular distance measuring and display system. Although the invention has been described with reference to an illustrative embodiment, it is not intended that the invention be limited to this illustrative embodiment. Those with skill in the art will recognize that many variation and modifications exist that do not depart from the true spirit of the invention. For example, while the invention has been described with reference to a single rear sensor, multiple sensors may be employed. Accordingly, it is intended that all such variations and modifications be included as fall within the scope of the appended claims.

1. A distance measuring and display system for use on a vehicle having a rear windshield, said system comprising:
at least one distance measuring sensor for measuring the distance between the rear of said vehicle and an obstacle at the rear of said vehicle; and
a display system coupled to said at least one sensor for displaying said distance on said rear windshield.

2. A distance measuring and display system according to claim 1 wherein said display system comprises a projection system.

3. A distance measuring and display system according to claim 2 wherein said projection system comprises:
a display; and
projection means for projecting an image onto said rear windshield.

4. A distance measuring and display system according to claim 3 wherein said display is a liquid crystal display.

5. A distance measuring and display system according to claim 3 wherein said projection means comprises a reflecting surface for reflecting an image of said display onto said rear windshield.

6. A distance measuring and display system according to claim 5 wherein said reflecting surface is a mirror.

7. A distance measuring and display system according to claim 5 where said reflecting surface is movable to adjust the position of an image projected onto said rear windshield.

8. An apparatus for projecting an image on a rear windshield of a vehicle, the apparatus comprising:
a display for generating an image; and
first means coupled to said display for projecting said image onto said rear windshield.

9. An apparatus according to claim 8 wherein said vehicle is an automobile.

10. An apparatus according to claim 8 wherein said image corresponds to indicia relating to a distance between the rear of said vehicle and an obstacle.

11. An apparatus according to claim 10 wherein said indicia is a numerical representation of said distance.

12. An apparatus according to claim 11 further comprising at least one distance measuring sensor coupled to said display for measuring said distance.

13. An apparatus according to claim 12 wherein said first means comprises a mirror.

14. An apparatus according to claim 13 wherein said display is an LCD display.

15. An apparatus according to claim 11 wherein said first means is adjustable to alter the position of said image on said rear windshield.

16. A method for displaying on a rear windshield of a vehicle a representation of a distance between the vehicle and an obstacle to the rear of the vehicle, the method comprising:
measuring said distance; and
displaying said representation on said rear windshield.

17. A method according to claim 16 wherein said displaying comprises:
generating a visual image of said representation; and
projecting the visual image onto said rear windshield.

18. A method according to claim 17 wherein said representation is a numerical representation.
